(19) United States
(12) Patent Application Publication
(10) Pub. No.: US 2002/0004409 A1
(43) Pub. Date: Jan. 10, 2002

(54) Portable electronic appliance provided with an integrated radio communication devivce having an antenna for transmitting and/or receiving electromagnetic waves

(75) Inventors: Eric Martinez, Sartrouville (FR); Roger Petit, Sartrouville (FR)

Correspondence Address: SUGHRUE, MION, ZINN, MACPEAK & SEAS, PLLC, Suite 800, 2100 Pennsylvania Avenue, N.W., Washington, DC, 20037-3213, US

(73) Assignee: ALCATEL

(21) Appl. No.: 09/897,139

(22) Filed: Jul. 3, 2001

(30) Foreign Application Priority Data
Jul. 10, 2000 (FR) 0008965

(51) Int. Cl. H04M 1/00

(52) U.S. Cl. 455/550; 455/90

(57) ABSTRACT

The invention relates to a portable electronic appliance including a device for transmitting and/or receiving radio signals integrated in the appliance, the device having an antenna for transmitting and/or receiving the radio signals, the antenna being in register with at least one portion of an outside face of said appliance that is for holding by a user. According to the invention the appliance includes means for creating a different touch sensation corresponding to said portion so as to hinder the user in holding said portion, thus freeing antenna radiation from disturbance due to the presence of a user's hand over said portion. The invention is particularly applicable to telephones, personal digital assistants, pocket computers, and domestic appliances.

The present invention relates to the field of portable electronic appliances, and it relates more particularly to a portable electronic appliance provided with an integrated radio communication device having an antenna for transmitting and/or receiving electromagnetic waves.

### BACKGROUND OF THE INVENTION

In the past, mobile telephones were intended solely to act as a telecommunications terminal in a mobile telecommunications network, and similarly digital personal assistants were intended to manage the personal data of their users by providing diaries, word processors, spreadsheets, electronic messaging, etc.

Because of the technological trend tending to make communication between different types of electronic appliance compatible, a portable telephone can now communicate with an office computer, for example. This is made possible in particular by the wireless technology known as “Bluetooth”. Thus, within a first appliance, a dedicated electronic integrated circuit (IC) implementing the specifications of this technology and acting via its own antenna serves to communicate in a specific frequency band that is compatible with another appliance likewise fitted with such an IC. It is common to refer to the unit containing the IC and its transmission antenna as a “Bluetooth” module.

In the state of the art, as shown in FIG. 1, a mobile telephone 1 is known that has a Bluetooth module 2, the module being fitted to the bottom of the telephone by coupling the module with a suitable connector of the telephone. However, that “kit” solution suffers from the drawback of lengthening the telephone when the module is fitted thereto.

To mitigate this problem, the Applicants' research and development teams have fitted mobile telephones with Bluetooth modules implanted within the case of the telephone, and more particularly within the battery compartment. Thus, the extra bulk due to adding the module is minimized since it occupies volume within the telephone that has previously been partially empty.

Unfortunately, the battery compartment is generally located in the back of the telephone where the user holds the telephone. The inventors have found that because the antenna of the Bluetooth module is at the back of the telephone, the presence of a user's hand in use intercepts a fraction of antenna radiation that would otherwise have contributed to the quality of the radio link.

The fraction of the electromagnetic radiation absorbed by a user's hand is lost for the function of the Bluetooth module which is to provide effective radio transmission and reception. This radiation which is lost for communications purposes is dissipated in the form of heat.

### OBJECTS AND SUMMARY OF THE INVENTION

The invention seeks to avoid this problem of a reduction in the efficiency of the antenna of a module integrated in a portable electronic appliance due to losses caused by a user's hand.

To this end, the invention provides a portable electronic appliance including a device for transmitting and/or receiving radio signals integrated in the appliance, the device having an antenna for transmitting and/or receiving the radio signals, the antenna being in register with at least one portion of an outside face of said appliance that is for holding by a user, said appliance including means for creating a different touch sensation corresponding to said portion so as to hinder the user in holding said portion, thus freeing antenna radiation from disturbance due to the presence of a user's hand over said portion.

Thus, by constraining the user to avoid holding the appliance via its portion in register with the antenna of the integrated device, the invention makes it possible to avoid the user's hand attenuating the transmitted signal.

In an embodiment, said means are provided on said portion.

In an embodiment, said means perform their function by the shape given to them, which shape does not match the shape of a user's hand.

In an embodiment, said means comprise a discontinuity in the planeness of said outside face, said discontinuity being constituted by the periphery of said portion.

In an embodiment, said means are shaped to constitute a projection.

In an embodiment, said means comprise at least one element from the group: roughnesses; a projecting portion; a granular surface.

In an embodiment, said means are marked with a warning recalling the presence of said device. The user is thus warned of the presence of a device of the invention having an antenna and will be encouraged to hold the telephone so as to avoid said portion and allow the antenna to radiate in optimum manner.

### BRIEF DESCRIPTION OF THE DRAWINGS

The invention will be better understood on reading the following description and on examining the accompanying figures. The figures are given by way of indication and do not limit the invention. In the figures:

FIG. 1 is a view of the front face of a prior art mobile telephone fitted with a protruding add-on radio module, as described above;

FIG. 2 is a three-quarters perspective view from behind of a mobile telephone constituting a first embodiment of the invention;

FIGS. 3a and 3b are perspective views, respectively a three-quarters face view and a three-quarters rear view, of the battery compartment of a mobile telephone constituting a second embodiment of the invention;

FIG. 4 is an exploded perspective view of FIG. 3a;

FIG. 5 shows a printed circuit card including a device of the invention and seen on view A-A of FIG. 4; and

FIG. 6 is a block diagram showing the main functions of the battery compartment and its connections with the remainder of the mobile telephone of FIGS. 3a and 3b.

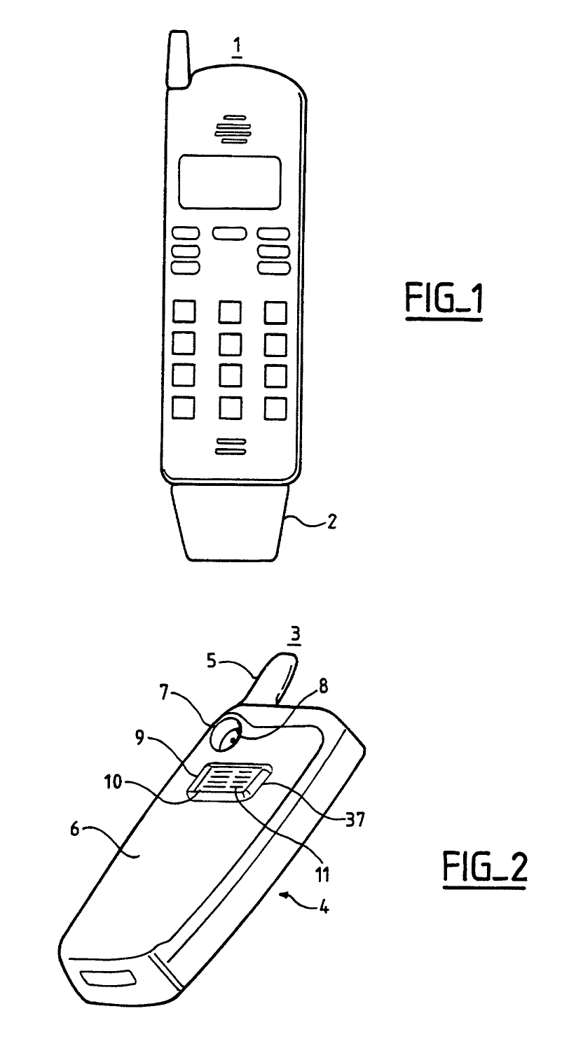

### MORE DETAILED DESCRIPTION

In the description below, elements performing identical functions in different figures are given the same references.

In addition, the invention is described in an application to portable telephone handsets for use in mobile telephone networks. Naturally, the invention applies more generally to other types of portable electronic appliance, such as a digital personal assistant, a portable or pocket computer, etc. The invention also applies to electronic appliances that are designed to be carried by their users while they are in use and that are fitted with a radio module, both in the field of home appliances (remote controls, digital disk reader and/or recorder, reader of data (usually audio) compressed using MP3 technology, etc.), and indeed to equipment included in a motor vehicle.

FIG. 2 is a three-quarters perspective view from behind of a portable telephone 3 constituting an embodiment of the invention. The telephone 3 has a front face 4 (also referred to as a “main shell”) presenting in conventional manner a screen, selection keys, an earphone, and a microphone (not shown). The telephone also has an antenna 5 for transmitting and receiving radio signals within the mobile telecommunications network in which it is to be found, e.g. the global system for mobile telecommunications (GSM).

In its back, the telephone 3 also has a compartment 6 which is detachable from the main shell and which houses the storage battery for electrically powering the telephone. An orifice 7 is arranged close to the antenna 5 and has a radio frequency (RF) connector 8 in the bottom thereof suitable for connecting the transceiver circuit (not shown) of the telephone to an antenna external to the telephone, e.g. a motor vehicle type antenna. The transceiver circuit is the circuit for transmitting and receiving signals within the mobile network.

On its surface that faces outwards (referred to as the “rear shell” 16), this compartment has a rectangular projection 9 whose top surface 10 is provided with surface roughness including stripes 11. This projection creates discontinuity in the planeness of the surface, with the discontinuity being formed around the periphery 37 of the projection. The description below gives greater details concerning the function of this projection and how to select its position on the surface of the compartment.

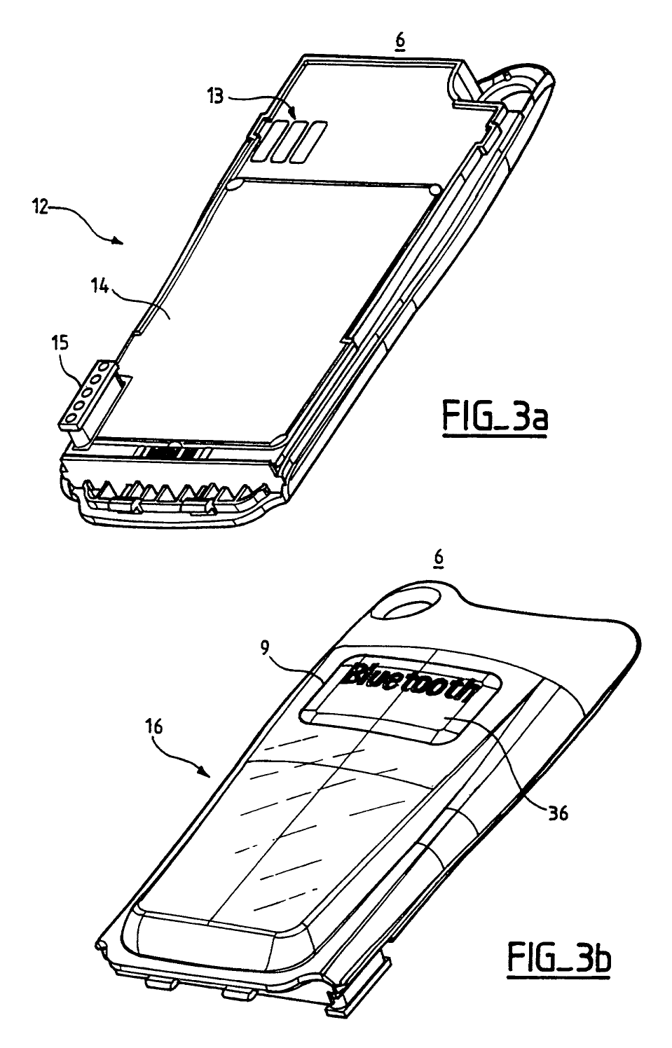

FIGS. 3a and 3b are perspective views, respectively a three-quarters front view and a three-quarters rear view, showing a battery compartment 6 separated from the shell of the telephone to which it is fitted in operation. FIG. 3a shows the inside face 12 of the compartment 6. There can be seen in particular a power supply connector 13 connecting the storage batter to the transceiver circuit of the telephone (i.e. the portion of the telephone dedicated to transmitting and receiving within the mobile network, and referred to below as the GSM transceiver circuit) and a metal protective plate 14. This plate is intended to protect against electromagnetic interference between the GSM transceiver circuit and the device of the invention which, in the present embodiment, is constituted by a Bluetooth module. In the description below, the device of the invention comprising an antenna corresponds to the Bluetooth module. It is clear that any other device fitted with an integrated antenna and incorporated in a portable electronic appliance could be envisaged, optionally in compliance with other radio specifications. A connector 15 having five connections serves to connect the module to the GSM transceiver circuit, two connections being for conveying digitized audio signals (one connection for reception and the other connection for transmission), two connections are for data transmission (one connection for reception and another connection for transmission), and a fifth connection is connected to ground.

FIG. 3b shows the rear shell 16 of the compartment 6 with its rectangular projection 9 including the word “Bluetooth” written on its top surface as a reminder of the presence of the associated module inside the telephone.

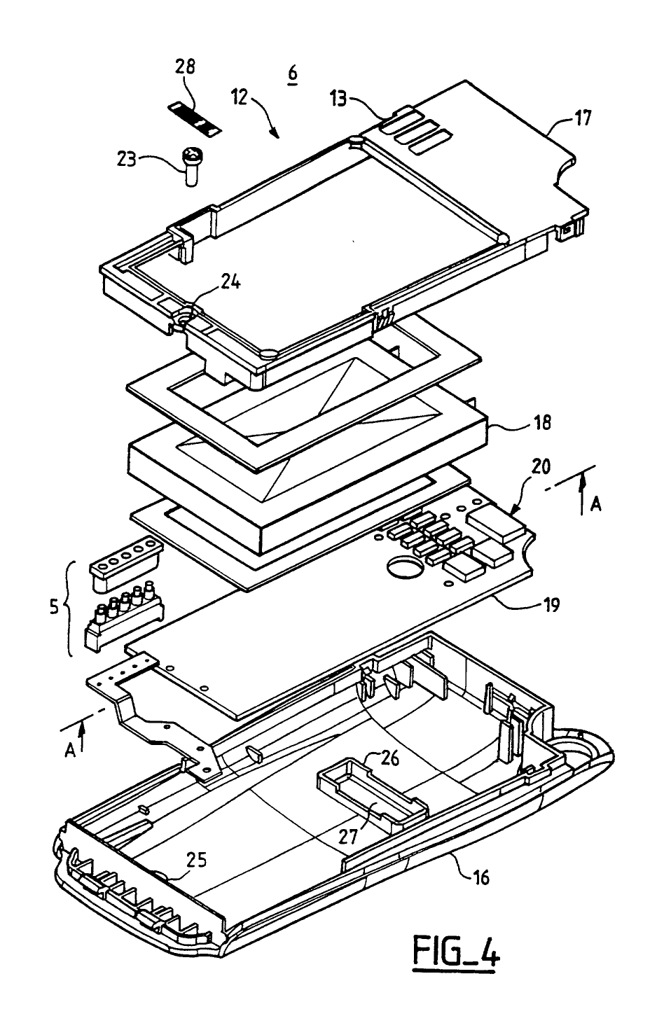

FIG. 4 is an exploded perspective view corresponding to FIGS. 3a. It comprises, going from the inside face 12 towards the outer shell 16:

a connection board 17 lying between the Bluetooth module which is in the compartment 6 and the GSM transceiver circuit, and connecting the storage battery 18 to power the transceiver circuit;

the storage battery, e.g. constituted by a lithium-ion cell;

a printed circuit card 19 having a first face that can be seen in FIG. 4 and that faces towards the face 12, which face carries a protection circuit 20 made up of fuses, transistors, . . . in conventional manner for the purpose of interrupting the power supply from the battery 18 to the GSM transceiver circuit and to the Bluetooth module; and

the rear shell 16 as seen from the inside.

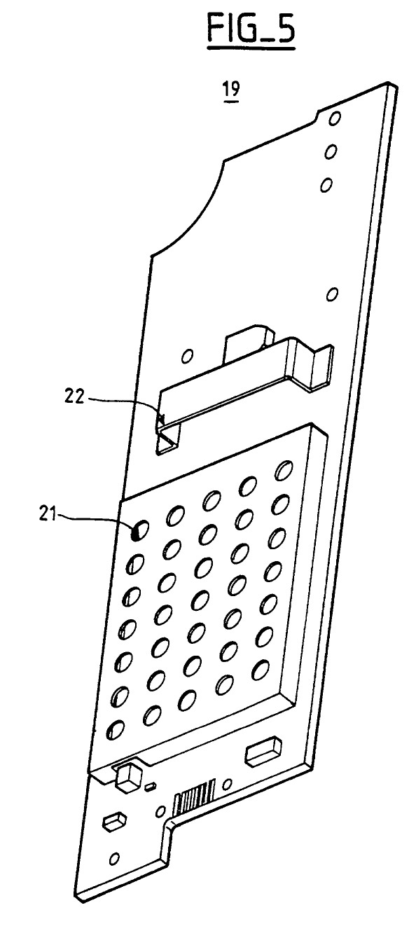

FIG. 5 is a view of the other face of the card 19, i.e. the face that is not visible in FIG. 4. This face carries shielding 21 housing the components of the Bluetooth module (not shown since they are hidden by the shielding) and a Π-shaped single loop antenna 22. This type of antenna is selected mainly for its selectivity, the purpose being to ensure good performance for the operating frequency band of the radio system defined by the Bluetooth standard while also providing sufficient filtering of frequencies associated with GSM transmission.

The various elements shown in FIG. 4 are assembled together to obtain the finished compartment by means of a screw 23 inserted in a corresponding orifice 24 of the connection board 17 and screwed into a tapped hole 25 for receiving it. Once the screw has been put into place, a guarantee seal 28 is placed on the screw to prevent any fraudulent disassembly. The battery element 18 bears against a surface of the card 19 that is complementary to the surface on which the protection circuit 20 is located.

A plastics housing 26 is arranged on the inside face of the rear shell in order to contain the antenna 22 when the card 19 is brought against said inside face. The side faces of this housing serve to protect the antenna 22 mechanically against any impact. Naturally, the entire housing must be made of a material that does not degrade the electromagnetic performance of the antenna (specifically the housing is made of a plastics material). The surface constituting the bottom 27 of the housing corresponds or is at least contained within the bottom (or back) surface 36 of the projection 9 (see FIG. 3b). As mentioned above, the presence of a projection on a surface that is intended to be held constitutes an impediment. The user tends to avoid a grip that covers the projection. Thus, in operation, the signal passing via the antenna 22 is transmitted and received mainly via the surface portion corresponding to the bottom 27. Since this portion is located, on the opposite surface, at the bottom of the projection, and since the presence of the projection encourages the user to hold the telephone in such a manner as to avoid covering the projection in the hand, radiation to or from the antenna 22 is less disturbed by the hand.

It is important to observe that the projection arranged over the Bluetooth antenna is to be distinguished from any esthetic effect insofar as it does not match the shape of a user's hand. Thus, the projection is formed for the sole purpose of making it difficult for the user to grasp said portion.

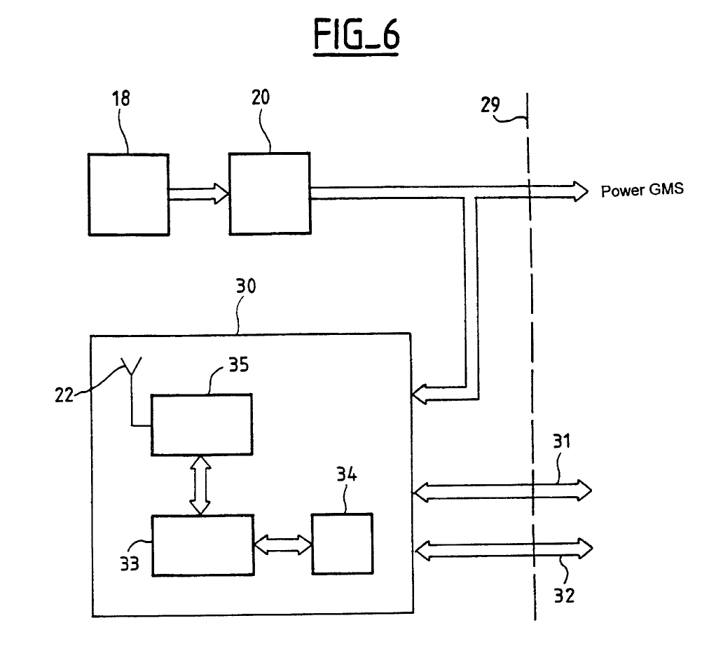

FIG. 6 is a block diagram showing the main functional blocks of the compartment 6 and its links with the GSM transceiver circuit. The compartment 6 is functionally represented on the left of a dashed line 29 separating it from the remainder of the telephone. There can be seen the battery element 18 connected to the protection circuit 20 which, in operation, receives electricity from the battery. If the protection circuit does not detect any anomaly, then electricity is delivered firstly to feed the GSM transceiver circuit and secondly to feed the Bluetooth module 30.

The module 30 is also connected to the GSM transceiver circuit via a first link 31 conveying digital audio signals and a second link 32 conveying digital data signals. These links 31 and 32 pass via the connector 15 with each link occupying two connections of the connector (one for sending signals and the other for receiving signals).

The module 30 includes an integrated circuit 33 connected to a memory 34 containing the software portion of the Bluetooth module, and to an antenna matching unit 35 for matching signals passing via the antenna 22 to which it is connected, in conventional manner. By way of example, this unit comprises a 50Ω impedance made using printed circuit technology.

Naturally, the invention is not limited to the embodiments described in the present application. Thus, the projection 9 can comprise over at least a fraction of its top surface or can be replaced by: stripes, projecting portions, roughnesses, a granular surface, an element capable of generating an electrical pulse on contact with human skin, etc.

In addition, the device of the invention can be constituted by any radio module.

1. A portable electronic appliance including a device for transmitting and/or receiving radio signals integrated in the appliance, the device having an antenna for transmitting and/or receiving the radio signals, the antenna being in register with at least one portion of an outside face of said appliance that is for holding by a user, said appliance including means for creating a different touch sensation corresponding to said portion so as to hinder the user in holding said portion, thus freeing antenna radiation from disturbance due to the presence of a user's hand over said portion:

2. An appliance according to claim 1, wherein said means are provided on said portion.

3. An appliance according to claim 2, wherein said means perform their function by the shape given to them, which shape does not match the shape of a user's hand.

4. An appliance according to claim 3, wherein said means comprise a discontinuity in the planeness of said outside face, said discontinuity being constituted by the periphery of said portion.

5. An appliance according to claim 2, wherein said means are shaped to constitute a projection.

6. An appliance according to claim 5, wherein said means comprise at least one element from the group:
roughnesses; a projecting portion; a granular surface.

7. An appliance according to claim 1, wherein said means are marked with a warning recalling the presence of said device.
